(19) United States
(12) Patent Application Publication
(10) Pub. No.: US 2021/0303640 A1
(43) Pub. Date: Sep. 30, 2021

(54) DOCUMENT MANAGEMENT SYSTEM, PROCESSING TERMINAL DEVICE, AND CONTROL DEVICE

(71) Applicant: FUJIFILM Business Innovation Corp., Tokyo (JP)

(72) Inventors: Shigeki KAMIYA, Tokyo (JP); Tetsuo IYODA, Kanagawa (JP)

(73) Assignee: FUJIFILM Business Innovation Corp., Tokyo (JP)

(21) Appl. No.: 17/017,683

(22) Filed: Sep. 11, 2020

(30) Foreign Application Priority Data
Mar. 25, 2020 (JP) 2020-054207

(51) Int. Cl. G06F 16/93; G06F 8/61

(52) U.S. Cl. CPC G06F 16/93; G06F 8/61

(57) ABSTRACT

A document management system includes a control device, a processing terminal, and a management apparatus. The control device and the processing terminal are disposed on a local network. The management apparatus is disposed on an external network connected to the local network and permits the control device to execute processing if the control device satisfies a predetermined security condition. The control device includes a first processor. The first processor is configured to: obtain environment information and processing terminal information from the processing terminal by using a communication method which satisfies a specific communication condition, the environment information being information concerning an environment of processing to be executed on a document by the processing terminal, the processing terminal information being information concerning the processing terminal; and permit the processing terminal to execute processing on the document if the environment information and the processing terminal information satisfy a specific processing condition. The processing terminal includes a second processor. The second processor is configured to execute processing on the document so as to generate a processed document if the control device has permitted the processing terminal to execute processing on the document.

### CROSS-REFERENCE TO RELATED APPLICATIONS

This application is based on and claims priority under 35 USC 119 from Japanese Patent Application No. 2020-054207 filed Mar. 25, 2020.

### BACKGROUND

### (i) Technical Field

The present disclosure relates to a document management system, a processing terminal device, and a control device.

### (ii) Related Art

A document management system that executes processing on a document so as to generate a processed document and manages the processed document is known.

Japanese Unexamined Patent Application Publication No. 2018-156409 discloses the following document management system. A processing device converts a document into a protected document by encrypting it, for example, and distributes the protected document to a document access terminal, which is a specified document receiver. The processing device then generates metadata including document receiver information and stores the generated metadata. The processing device also registers the metadata in a local metadata server, which is a host device. A processing device positioned at another location checks whether a user using a document access terminal is registered in this processing device. If the user is not registered in the processing device, the processing device requests a local user ID server, which is a host device, to conduct user authentication. If the processing device does not have metadata of a protected document requested from a document access terminal, it obtains the metadata from the local metadata server and sends the metadata to the document access terminal.

### SUMMARY

To generate a processed document by executing document processing, a considerably heavy processing load is imposed accordingly. If services for generating processed documents are widely provided via a network, such as the Internet, and if a central server generates processed documents in a concentrated manner, the processing load concentrates on the central server and the network congestion occurs, thereby making processing responses poor.

In contrast, if a processing device is disposed on a local network in each organization, such as in the office, to take charge of generating processed documents instead of the above-described central server, poor responses can be avoided. In this case, however, a new issue may arise depending on the processing quality of the processing devices disposed in the individual local networks. For example, if a processing device does not perform necessary updates on a regular basis, a processed document generated in such a processing device does not satisfy a required quality level, such as a security level, which may cause a leakage of the processed document.

To deal with this issue, the following system may be provided. A management apparatus that manages processing devices disposed on individual local networks may be disposed on an external network connected to the local networks. When a processing device satisfies predetermined security conditions, the management apparatus permits this processing device to execute processing. For example, the management apparatus manages the status of each processing device and determines whether to permit a corresponding processing device to execute processing, based on the status of this processing device.

In the above-described system, however, if a processing device executes processing on documents sent from individual devices disposed on the same local network, a load concentrates on the processing device, which makes processing responses poor. To address this issue, part of processing to be executed by a processing device may be delegated to another device. With this configuration, however, a document may leak from this device, thereby failing to achieve secure document processing.

Aspects of non-limiting embodiments of the present disclosure relate to a document management system which includes devices disposed on individual local networks and causes them to execute document processing and which achieves secure document processing while preventing a load from being concentrated on a specific device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a document management system including a control device, a processing terminal, and a management apparatus. The control device and the processing terminal are disposed on a local network. The management apparatus is disposed on an external network connected to the local network and permits the control device to execute processing if the control device satisfies a predetermined security condition. The control device includes a first processor. The first processor is configured to: obtain environment information and processing terminal information from the processing terminal by using a communication method which satisfies a specific communication condition, the environment information being information concerning an environment of processing to be executed on a document by the processing terminal, the processing terminal information being information concerning the processing terminal; and permit the processing terminal to execute processing on the document if the environment information and the processing terminal information satisfy a specific processing condition. The processing terminal includes a second processor. The second processor is configured to execute processing on the document so as to generate a processed document if the control device has permitted the processing terminal to execute processing on the document.

### BRIEF DESCRIPTION OF THE DRAWINGS

An exemplary embodiment of the present disclosure will be described in detail based on the following figures, wherein:

FIG. 1 is a block diagram illustrating the schematic configuration of a document management system;

FIG. 2 is a block diagram illustrating examples of the hardware configurations of a processing terminal, a control device, and a management system;

FIG. 3 illustrates an example of the data content of metadata;

FIG. 4 illustrates an example of the content of data managed by a user ID server;

FIG. 5 illustrates an example of the content of data managed by a document ID (DID) server;

FIG. 6 illustrates an example of the content of data managed by a control device management server;

FIG. 7 illustrates an example of the configuration of a control device and an example of the content of data stored in the control device;

FIG. 8 is a block diagram illustrating examples of the functional configurations of the processing terminal and the control device;

FIG. 9 illustrates a processing procedure for distributing and accessing a document in the document management system;

FIG. 10 is a block diagram illustrating an example of the configuration of a document management system including an in-house management system; and

FIG. 11 is a block diagram illustrating another example of the configuration of the document management system.

### DETAILED DESCRIPTION

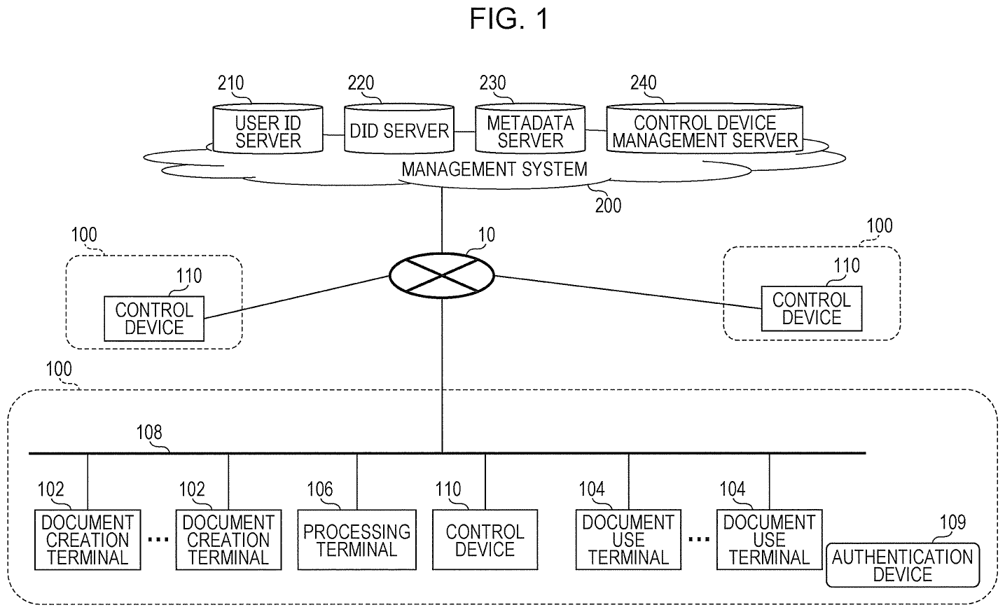

FIG. 1 is a block diagram illustrating the schematic configuration of a document management system according to an exemplary embodiment.

In the case of a paper document, a user can make a copy of it or give it to another user as desired, and a user receiving this paper document can read it. The risk of an information leakage is thus extremely high for paper documents.

In contrast, the document management system according to the exemplary embodiment provides environments where digital documents are handled securely so that the risk of a leakage of document information can be decreased. A document is content data that can be distributed as one unit, such as one file. Documents are not restricted to a particular type of data. Examples of documents are text data, document data created by word-processing software, spreadsheet data created by spreadsheet software, computer aided design (CAD) data, image data, video data, sound data, multimedia data, page data displayed with the use of a web browser, and data which is created, edited, or read on a personal computer (PC) and may be printed out.

This document management system includes plural local systems 100 and a management system 200. The management system 200 conducts management concerning the local systems 100, in particular, control devices 110, which will be discussed later. The management system 200 is able to communicate with the local systems 100 via a wide area network 10, such as the Internet.

The local system 100 includes one or more document creation terminals 102, one or more document use terminals 104, one or more processing terminals 106, and a control device 110 that are connected to a local network 108. The local network 108 is a private network disposed in an organization, such as a company. The private network is formed as a local area network (LAN), for example. The local network 108 is protected from the wide area network 10 by a firewall, for example. Basically, one control device 110 is disposed within one local system 100. If the private network is formed in an organization on a large scale, each network segment forming the private network may be used as a local system 100, and a control device 110 may be disposed within each network segment serving as a local system 100. For example, a network segment disposed in a department of a certain company is used as the local system 100 for this department, and one control device 110 is installed in this network segment. In the example shown in FIG. 1, a local system 100 which includes a control device 110 as the core is formed in each company or each department of a company, and the multiple control devices 110 are managed by the management system 200.

The document creation terminal 102 is used for creating a document. Examples of the document creation terminal 102 are a desktop PC, a notebook PC, a workstation, a tablet terminal, a smartphone, a multifunction device, a scanner, a fax machine, and a digital camera. In the document creation terminal 102, an application for creating and editing a document is installed. Software for requesting the document management system to distribute a created document is also installed in the document creation terminal 102. This software may be installed in the document creation terminal 102 as a device driver for sending and receiving information to and from the processing terminal 106, which will be discussed later, or may alternatively be installed in the document creation terminal 102 using a web application.

Examples of the processing terminal 106 are a desktop PC, a notebook PC, a workstation, a tablet terminal, a smartphone, a multifunction device, a scanner, a fax machine, and a digital camera. The processing terminal 106 executes processing on a document created by a document creation terminal 102 so as to generate a processed document. Processing to be executed on a document created by the document creation terminal 102 (hereinafter such a document will be called an original document) can also be regarded as processing for encoding this original document into a processed document. In this sense, the processing terminal 106 is a type of encoder. A processed document is a document generated as a result of executing processing on an original document.

Processing to be executed on a document is protection processing, for example. The processing terminal 106 executes protection processing on an original document so as to generate a protected document. The protected document is an example of a processed document. Protection processing is processing for converting an original document into a protected document that can be used in a secure environment. An example of protection processing is encryption processing. Encryption processing is executed on an original document so as to generate an encrypted document, which is an example of a protected document. For example, the processing terminal 106 encrypts an original document in such a manner that the encrypted document can be decrypted only by a user specified as a document receiver user.

Another example of processing to be executed on an original document is processing for making it possible to use this document in the document management system. The processing terminal 106 executes this processing on an original document so as to generate a document that can be used in the document management system. The generated document is an example of a processed document. This processing is conversion processing for converting an original document into data in the dedicated format designed for the document management system. As a result of executing conversion processing on an original document, a document converted into the dedicated format is generated.

Another example of processing to be executed on an original document is both of the above-described protection processing and conversion processing. In this case, the processing terminal 106 converts an original document into data in the dedicated format designed for the document management system and also encrypts this data in such a manner that the encrypted document can be decrypted only by a user specified as a document receiver user. A document generated as a result of executing both of protection processing (encryption processing, for example) and conversion processing is an example of a processed document. Regarding the order of format conversion and data encryption, either one of them may be executed first.

A description will be given, assuming that the processing terminal 106 executes both of protection processing, such as encryption processing, and conversion processing on an original document, for example. A document generated as a result of executing protection processing and conversion processing will be called an eDoc file. Nonetheless, the processing terminal 106 may execute only one of protection processing and conversion processing on an original document.

The processing terminal 106 creates metadata of a processed document and sends the created metadata to the control device 110 by using a communication method which satisfies a specific communication condition (for example, a secure communication method, such as secure sockets layer (SSL)). The metadata is sent from the control device 110 to the management system 200, which is the host system, and is registered in the management system 200. Metadata includes bibliographic items of a processed document, information concerning document receivers to which the processed document will be distributed, and information concerning a key to be used by each document receiver to decrypt the encrypted document (if the processed document is a protected document). Metadata also indicates the processing terminal ID, which is identification information for identifying the processing terminal 106 which has executed processing on the document associated with this metadata. Metadata includes multiple items of data. A corresponding device or user adds, edits, or updates the metadata in accordance with the function provided by a service in the document management system.

For example, some items of data which form metadata are set by a user having made a request to register a document in the document management system, some other items of data are created by the processing terminal 106, and some other items of data are created by the control device 110. The values of some items of data forming metadata may be set by the management system 200 or a document use terminal 104. The processing terminal 106 stores a processed document and its metadata and sends the processed document and its metadata to a document use terminal 104 selected as a document receiver by a user. Instead of from the processing terminal 106, metadata may be sent from the management system 200 to the document use terminal 104.

If a combination of the processing terminal 106 and the control device 110 matches the predetermined content, communication using a communication method which satisfies a specific communication condition is established between the processing terminal 106 and the control device 110. For example, in the control device 110, a processing terminal 106 authorized to communicate with the control device 110 is registered in advance. Then, a combination of the control device ID, which is identification information for identifying the control device 110, and the processing terminal ID, which is identification information for identifying the processing terminal 106, is created in advance and is stored in the control device 110. At the start of communication with the control device 110, the processing terminal 106 sends the processing terminal ID to the control device 110. Upon receiving the processing terminal ID, the control device 110 checks whether a combination of the control device ID and the received processing terminal ID is stored in the control device 110. If such a combination is stored in the control device 110, the control device 110 permits the processing terminal 106 to communicate with the control device 110. Communication between the control device 110 and the processing terminal 106 is then established so that they can send and receive information with each other. If the combination of the control device ID and the processing terminal ID is not stored in the control device 110, the control device 110 does not permit the processing terminal 106 to communicate with the control device 110. In this case, communication between the control device 110 and the processing terminal 106 is not established and they are unable to send and receive information with each other.

Multiple processing terminals 106 may be registered in one control device 110. In this case, for each processing terminal 106, a combination of the control device ID, which is the ID of the control device 110, and the processing terminal ID, which is the ID of a processing terminal 106, is stored in the control device 110.

An eDoc file, which is an example of a processed document, is a file converted into the dedicated format and encrypted from an original document, and is also called an eDoc body. To use an eDoc file, such as to access the eDoc file, metadata associated with this eDoc file is required. A combination of an eDoc file and the associated metadata form a complete file that can be used. Hereinafter, a combination of an eDoc file and the associated metadata will be called an “eDoc”.

The control device 110 obtains environment information and processing terminal information from the processing terminal 106 by using a communication method which satisfies a specific communication condition. The environment information is information concerning the environments of document processing to be executed by the processing terminal 106. The processing terminal information is information concerning the processing terminal 106. If the obtained environment information and processing terminal information satisfy specific processing conditions, the control device 110 permits the processing terminal 106 to execute document processing. The control device 110 then sends permission information to the processing terminal 106. The permission information is then stored in the processing terminal 106. The processing terminal 106 is allowed to execute document processing. An effective period may be set in the permission information. In this case, the processing terminal 106 is allowed to execute document processing within this effective period. If multiple processing terminals 106 are registered in the control device 110, the control device 110 judges for each processing terminal 106 whether to permit the processing terminal 106 to execute document processing.

The environment information includes at least one of information concerning security software installed in the processing terminal 106, such as installation information and operating information, information concerning an operating system (OS) installed in the processing terminal 106, such as version information, and information concerning software to be used for document processing, that is, software used for encoding, such as version information and identification information.

The processing terminal information is the processing terminal ID, which is identification information for identifying the processing terminal 106, for example.

If the processing terminal information (processing terminal ID, for example) obtained from the processing terminal 106 is stored in the control device 110 and if the operating status of the security software installed in the processing terminal 106, the version of the OS, and the version of the software used for protection processing satisfy predetermined conditions (if the version of software is a predetermined version or higher, for example), it is determined that the environment information and the processing terminal information satisfy the specific processing conditions. In this case, the control device 110 permits the processing terminal 106 to execute document processing. If the operating status of software installed in the processing terminal 106 and the versions of the OS and software do not satisfy the predetermined conditions, such as if the version of software is lower than the predetermined version, it is determined that the environment information and the processing terminal information do not satisfy the specific processing conditions. In this case, the control device 110 does not permit the processing terminal 106 to execute document processing.

The timing at which the control device 110 judges whether to provide permission to the processing terminal 106 may be when the processing terminal 106 is powered ON and is started, when software used for processing is started, or when the processing terminal 106 attempts to execute processing after the effective period of the permission information has elapsed.

The control device 110 may contain a function of an access point of a wireless LAN. This enables the document creation terminal 102 to communicate with the control device 110 by using a wireless LAN.

The document use terminal 104 is a terminal for using a processed document, such as an eDoc file. For example, the document use terminal 104 is used for accessing a processed document. Accessing a document means using a processed document in a mode according to the content of information represented by this document. For example, if a processed document represents information concerning data created by word-processing software or a drawing, accessing the document means that a user reads or views the document displayed by the document use terminal 104. If a processed document represents information concerning sound, accessing the document means that a user listens to sound played back by the document use terminal 104. The document use terminal 104 is constituted by a general-purpose computer, such as a desktop PC, a notebook PC, a workstation, a tablet terminal, or a smartphone, in which a viewer application for accessing a processed document is installed. Alternatively, a read only terminal, such as a digital book terminal, having a function similar to a viewer application, may be used as the document use terminal 104. The viewer application has a function of decrypting an encrypted protected document by using metadata information and a function of decoding data indicating a processed document described in the dedicated format into data in a readable format. A computer that does not have a viewer application that can be used in the document management system is unable to decode data in the dedicated format into data in a readable format.

In addition to decrypting, decoding, and displaying functions for a processed document, the document use terminal 104 may have a function of receiving additional processing (that is, editing) performed on a displayed document from a user. The content of the document edited by the user is different from that of the originally processed document. However, the edited document may be sent from the document use terminal 104 to the processing terminal 106 and be registered in the document management system, in other words, the edited document may be re-encoded to the originally processed document. In this manner, one terminal may have the functions of both the document creation terminal 102 and the document use terminal 104. In an eDoc, access rights (access right information contained in metadata, which will be discussed later) to be provided to a user are set. The access rights may include write restrictions and redistribution restrictions for the eDoc. If such restrictions are defined in the access right information set in the eDoc, the document use terminal 104 receives an editing operation from a user only within the range of the write restrictions and also receives a request to redistribute the edited eDoc file to receivers only within the range of the redistribution restrictions.

In the exemplary embodiment, as a tool for authenticating a user using the document management system, an authentication device 109 that is carried by a user is used. As in an integrated circuit (IC) card, the authentication device 109 contains identification information unique to the user carrying the authentication device 109 and executes data processing for user authentication in response to a request from an external device. The authentication device 109 may alternatively be a mobile terminal, such as a smartphone, having functions similar to those of the above-described IC card. The document use terminal 104 and the document creation terminal 102 have a function of communicating with the authentication device 109 by using a wireless communication protocol, such as near field communication (NFC). The document use terminal 104 and the document creation terminal 102 exchange user authentication information with the authentication device 109 in accordance with a predetermined protocol, and authenticate a user carrying the authentication device 109. Alternatively, user authentication may be conducted by a server of the document management system, such as the control device 110 or the management system 200, and the document use terminal 104 and the document creation terminal 102 may only transfer data between the server and the authentication device 109. The document use terminal 104 and the document creation terminal 102 may alternatively contain the functions of the authentication device 109.

For each user using the document creation terminal 102 and for each user using the document use terminal 104, the document creation terminal 102 and the document use terminal 104 each store authentication information (user ID and password) concerning a corresponding user, the processing terminal ID and address information concerning a default processing terminal 106, the control device ID and address information concerning a default control device 110, address information concerning a host device (such as the management system 200 or an in-house management system 160, which will be discussed later), security certificates of the control device 110 and the host device, and an encryption key used for encrypting a communication channel.

The management system 200 manages the control device 110 disposed in each local system 100. The management system 200 also manages metadata of processed documents and provides metadata of a certain processed document to a document use terminal 104 in response to a request. The management system 200 is constituted by one computer or multiple computers that can communicate with each other. The management system 200 has functions serving as a user ID server 210, a document ID (DID) server 220, a metadata server 230, and a control device management server 240.

The user ID server 210 manages information concerning each user using the document management system. Users using the document management system are divided into two levels. One level of a user is a user having made a contract to use the document management system with the operator of the document management system. The other level of a user is a general user using the document management system to register or access a document in accordance with the contract. A typical mode of the use of the document management system is as follows. The user having made a contract (contractor user) is a company. The control device 110 is installed in the local network 108 of this company. The employees of this company use the document management system as general users via the control device 110. The user ID server 210 stores and manages information concerning the contractor user and each of the general users.

The DID server 220 manages DIDs, which are IDs of processed documents. A DID is appended to a processed document by the processing terminal 106 having created this processed document. The DID server 220 provides a DID issue right and a DID issue limit to the control device 110. The DID issue limit is a restriction regarding the maximum number of DIDs to be issued. The DID server 220 records DIDs issued by the control device 110 within the range of the DID issue right and the DID issue limit. The DID server 220 thus prevents unauthorized issuing of DIDs and also detects a document having a dishonestly issued DID.

The metadata server 230 stores and manages metadata of each of processed documents (eDoc files). In response to a request to send metadata of a processed document (eDoc file) from a user via a document use terminal 104, the metadata server 230 sends the metadata to the document use terminal 104 if the user is an authorized user. The metadata server 230 judges whether a user is an authorized user by determining whether a combination of this user and the document use terminal 104 used for sending the request matches a combination of a document receiver user and a document-receiver document use terminal 104 indicated in document receiver information. The document receiver information is contained in metadata which is stored in the metadata server 230 in association with the DID of the processed document (eDoc file). The DID of the eDoc file is contained in the request from the user. Details of the document receiver information will be discussed later.

The control device management server 240 manages the status of each control device 110.

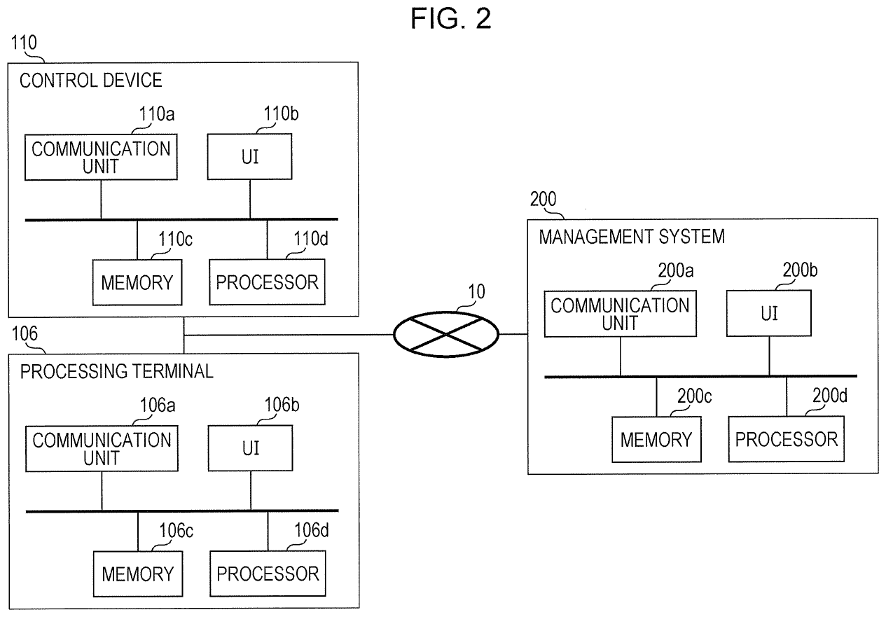

Examples of the hardware configurations of the processing terminal 106, the control device 110, and the management system 200 will be described below with reference to FIG. 2.

The processing terminal 106 includes a communication unit 106a, a user interface (UI) 106b, a memory 106c, and a processor 106d.

The communication unit 106a is a communication interface, such as a network interface, having a communication chip, and has a function of sending data to another device or system and a function of receiving data from another device or system.

The UI 106b includes at least one of a display and an operation unit. The display is a liquid crystal display or an electroluminescence (EL) display, for example. The operation unit is a keyboard, input keys, or an operation panel, for example. The UI 106b may be a touchscreen which serves both as the display and the operation unit.

The memory 106c is a device having one or multiple storage regions for storing data. The memory 106c is one of a hard disk drive (HDD), various memory units (such as a random access memory (RAM), a dynamic random access memory (DRAM), and a read only memory (ROM)), and other types of storage devices (such as an optical disc), or a combination thereof.

The processor 106d controls the operations of the individual elements of the processing terminal 106. The processor 106d may include a memory. The functions of the processing terminal 106 are implemented by the processor 106d. The processor 106d corresponds to an example of a second processor.

The control device 110 includes a communication unit 110a, a UI 110b, a memory 110c, and a processor 110d.

The communication unit 110a is a communication interface, such as a network interface, having a communication chip, and has a function of sending data to another device or system and a function of receiving data from another device or system.

The UI 110b includes at least one of a display and an operation unit. The display is a liquid crystal display or an EL display, for example. The operation unit is a keyboard, input keys, or an operation panel, for example. The UI 106b may be a touchscreen which serves both as the display and the operation unit.

The memory 110c is a device having one or multiple storage regions for storing data. The memory 110c is one of an HDD, various memory units (such as a RAM, a DRAM, and a ROM), and other types of storage devices (such as an optical disc), or a combination thereof.

The processor 110d controls the operations of the individual elements of the control device 110. The processor 110d may include a memory. The functions of the control device 110 are implemented by the processor 110d. The processor 110d corresponds to an example of a first processor.

The management system 200 includes a communication unit 200a, a UI 200b, a memory 200c, and a processor 200d.

The communication unit 200a is a communication interface, such as a network interface, having a communication chip, and has a function of sending data to another device or system and a function of receiving data from another device or system.

The UI 200b includes at least one of a display and an operation unit. The display is a liquid crystal display or an EL display, for example. The operation unit is a keyboard, input keys, or an operation panel, for example. The UI 200b may be a touchscreen which serves both as the display and the operation unit.

The memory 200c is a device having one or multiple storage regions for storing data. The memory 200c is one of an HDD, various memory units (such as a RAM, a DRAM, and a ROM), and other types of storage devices (such as an optical disc), or a combination thereof.

The processor 200d controls the operations of the individual elements of the management system 200. The processor 200d may include a memory. The functions of the management system 200 are implemented by the processor 200d. The processor 200d corresponds to an example of a third processor. The user ID server 210, the DID server 220, the metadata server 230, and the control device management server 240 of the management system 200 may each include a processor, and the functions of the user ID server 210, the DID server 220, the metadata server 230, and the control device management server 240 may be implemented by the corresponding processors.

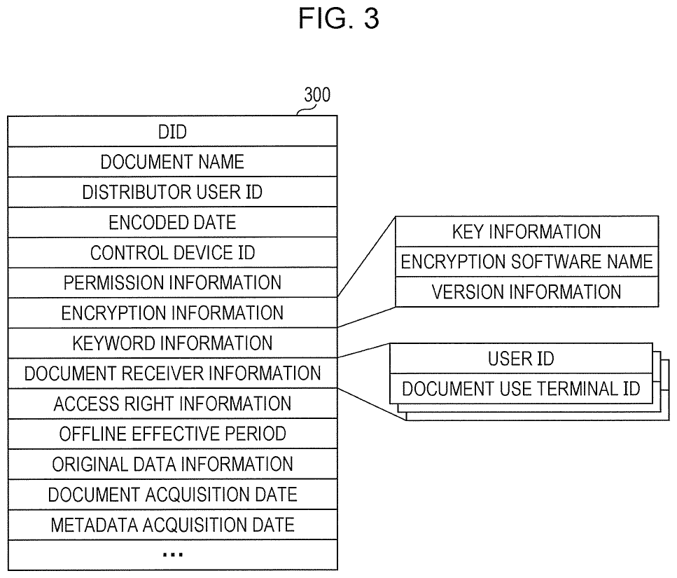

An example of the data content of metadata 300 of a processed document will be explained below with reference to FIG. 3. In this example, the metadata of an eDoc file will be discussed.

As discussed above, the metadata 300 includes plural items of data. “DID” is a document ID appended by the processing terminal 106 that has generated the eDoc file associated with the metadata 300. “Document name” is the name or the title of this eDoc file.

“Distributor user ID” is the ID of a user having distributed this eDoc file, that is, the ID of a user who has requested the processing terminal 106 to register the document by using the document creation terminal 102 and distributed the document via the processing terminal 106. Such a user will be called a distributor user.

“Encoded date” is a date on which the eDoc file is created as a result of the processing terminal 106 encoding the document received from the document creation terminal 102. “Control device ID” is identification information concerning the control device 110 that has permitted the processing terminal 106 to execute processing (to create the eDoc file). “Permission information” includes information indicating the processing terminal ID of the processing terminal 106 that has created the eDoc file and information indicating that the control device 110 has permitted the processing terminal 106 to create the eDoc file. “Encryption information” is information concerning encryption conducted when the eDoc file is created and indicates the name and the version of encryption software, and also includes key information indicating the key for decrypting the encrypted file. “Keyword information” is a list of keywords extracted from the eDoc file (or the original data). The keyword information is used for searching for this eDoc file, for example.

“Document receiver information” indicates a user and a document use terminal 104 selected as document receivers of this eDoc file by the distributor user. In the example in FIG. 3, the document receiver information indicates, for each document receiver user, a user ID of the receiver user and the ID of the document use terminal 104 used by this user. If multiple document use terminals 104 are specified for one user, combinations of the user ID of this user and the IDs of these multiple document use terminals 104 are indicated in the document receiver information.

The authenticity of the eDoc file is verified in accordance with whether the processing terminal ID of the processing terminal 106 which has created this eDoc file and the control device ID that has permitted the processing terminal 106 to create the eDoc file are linked with the metadata of the eDoc file. If the processing terminal ID and the control device ID are linked with the metadata of the eDoc file, it means that the processing terminal 106 having this processing terminal ID is authorized to create the eDoc file by the control device 110 having this control device ID. It is thus validated that the eDoc file generated by this processing terminal 106 has been generated by the processing terminal 106 authorized by the control device 110. That is, the authenticity of the eDoc file is verified. If the processing terminal ID and the control device ID are not linked with the metadata of the eDoc file, it means that the eDoc file corresponding to the metadata has been generated by a processing terminal 106 which is not authorized by the control device 110. That is, the authenticity of the eDoc file is not verified. Verification of the authenticity of the eDoc file is performed by the management system 200, for example.

In another example, if document receiver users may use any of document use terminals 104 selected as document receiver terminals to use the eDoc file, the document receiver information includes a list of the IDs of the document receiver users and a list of the IDs of the document-receiver document use terminals 104. For example, as options of the document-receiver document use terminals 104, a common terminal for a certain department of a company and a terminal installed in the office or a meeting room of this department may be assumed. The common terminal and the terminal installed in the office of the department may be used by anyone in the department. However, the distributor user knows that these terminals belong to the department and are less likely to be taken outside the department without permission. Such terminals are thus legitimate as document receivers for a confidential document. In this manner, the mode of use in which document receiver users may use any of document use terminals 104 selected as document receiver terminals is also possible.

“Access right information” indicates rights concerning the use of the eDoc file which is provided to a document receiver user by a distributor user.

“Offline effective period” is information indicating the length of the effective period for the metadata 300. It is now assumed that the metadata 300 of the eDoc file has already been obtained from the management system 200 and cached in the document use terminal 104. In this case, even when the document use terminal 104 is unable to access the management system 200 because it is offline, it may decrypt the eDoc file by using the encryption information included in the metadata 300 and display it if the period of time elapsed from the date on which the metadata 300 has been acquired is within the offline effective period. If the document use terminal 104 is offline and if the offline effective period has already elapsed, the document use terminal 104 does not decrypt the eDoc file or display it. If the document use terminal 104 is able to access the management system 200 because it is online, in response to an instruction to access the eDoc file from a user, the document use terminal 104 obtains the latest metadata of the eDoc file from the management system 200 (more specifically, the metadata server 230) and uses it.

“Original data information” is information indicating whether the original data from which the eDoc file is generated (encoded) is stored, and if it is stored, information indicating the storage location, such as a uniform resource locator (URL), of the original data is indicated in “Original data information”. The original data is a document sent from the document creation terminal 102 to the processing terminal 106, that is, the document which has not been subjected to processing, or application data of this document (data created by word-processing software which has not been converted into PDL data if the document is PDL data), or both of the document and its application data.

“Document acquisition date” is a date on which the document use terminal 104 has acquired the file of the eDoc body data, that is, the eDoc file. “Metadata acquisition date” is a date on which the document use terminal 104 has acquired the latest metadata of the eDoc file sent from the metadata server 230 and currently cashed in the document use terminal 104. The document acquisition date and the metadata acquisition date are not included in the metadata stored in the management system 200, and are added later by the document use terminal 104 to the metadata obtained from the metadata server 230 so that the metadata can be managed in the document use terminal 104.

Among the items of the metadata 300 shown in FIG. 3, the encoded date, keyword information, and permission information are items added to the metadata by the processing terminal 106. The DID is issued by the control device 110, and the encryption information is managed by the control device 110. The DID and encryption information are sent from the control device 110 to the processing terminal 106 by using a secure communication method, such as SSL, and are added to the metadata by the processing terminal 106. The document name, distributor user ID, document receiver information, access right information, offline effective period, and original data information, which are based on the document and attribute data sent from the document creation terminal 102 to the processing terminal 106, are added to the metadata by the processing terminal 106.

An example of the content of data managed by each of the user ID server 210, the DID server 220, the metadata server 230, and the control device management server 240 of the management system 200 will be described below.

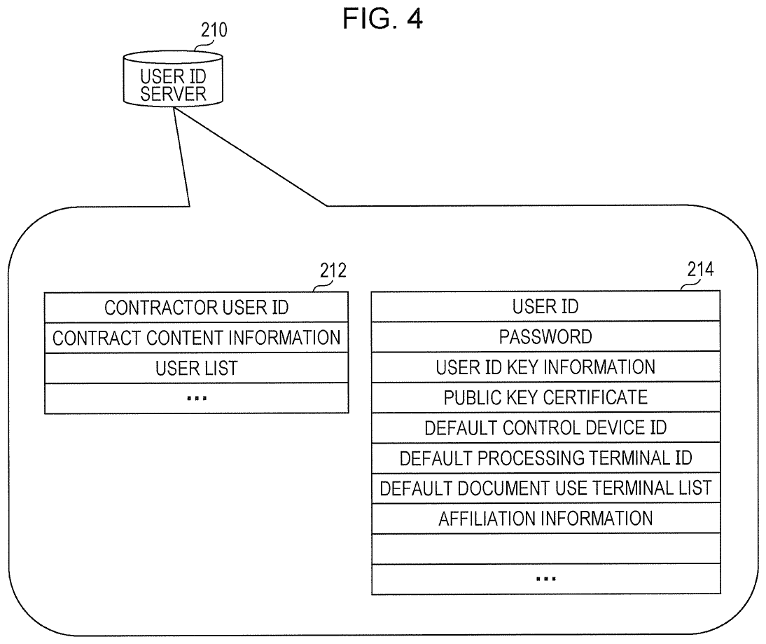

An example of the content of data managed by the user ID server 210 will first be discussed below with reference to FIG. 4. In the user ID server 210, contractor user data 212 concerning each contractor user and general user data 214 concerning each general user are registered.

The contractor user data 212 includes various items of data indicating a contractor user ID, contract content information, and a user list. The contractor user ID is the identification information concerning a contractor user having made a contract with the operator of the document management system. Examples of the contractor user are an organization or a department within the organization. The user list is a list of the IDs of general users using this document management system in accordance with the contract. An example of the general users is members belonging to an organization, which is the contractor user.

The general user data 214 includes various items of data indicating a general user ID, a password, user ID key information, a public key certificate, a default control device ID, a default processing terminal ID, a default document use terminal list, and affiliation information. The user ID key information is authentication information concerning a certain user to be used by the authentication device 109 of this user. The public key certificate is a digital certificate which certifies the public key of this user. The default control device ID is the ID of the control device 110 in which this user is registered. Usually, a user is registered in the control device 110 installed in the department of the user, and this control device 110 is the default control device for this user. The default processing terminal ID is the ID or IDs of one or more processing terminals mainly used by the user. The default document use terminal list is a list of the ID or IDs of one or more document use terminals mainly used by the user. The document use terminals included in this list are terminal options to be used when eDoc is distributed to the user. The affiliation information is information for identifying the organization or a department of the organization to which the user belongs, and is the ID of the contractor user of the organization or the department.

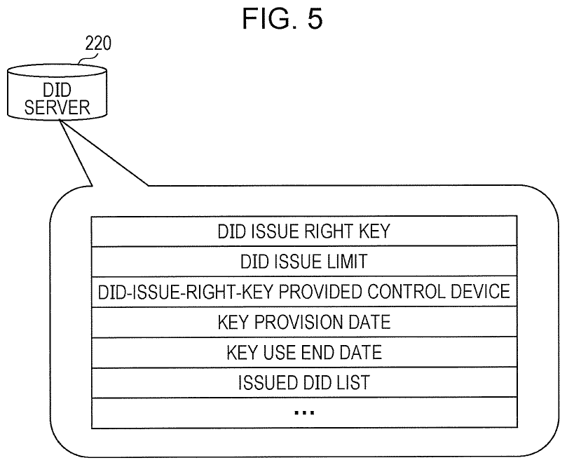

An example of the content of data managed by the DID server 220 will be discussed below with reference to FIG. 5.

As shown in FIG. 5, the DID server 220 stores, for each DID issue right key provided to a control device 110, items of information indicating a DID issue limit, a DID-issue-right-key provided control device, a key provision date, a key use end date, and an issued DID list.

The DID issue right key is key information (randomly generated character string, for example) which certifies a DID issue right provided by the DID server 220 to the control device 110. The control device 110 adds the DID issue right key provided by the DID server 220 to a DID issued by the control device 110 to certify that this DID has been issued under the legitimate issue right.

The DID issue limit indicates the maximum number of DIDs that the control device 110 can issue under the DID issue right key. In other words, the DID issue limit indicates the maximum number of documents to which DIDs can be appended. After the control device 110 has received a pair of a DID issue right key and a DID issue limit from the DID server 220, it can provide unique DIDs to up to the maximum number of eDoc files indicated by the DID issue limit.

The DID-issue-right-key provided control device indicates the ID of the control device 110 to which the DID issue right key and the DID issue limit have been provided. The key provision date is a date on which the DID issue right key is provided to the control device 110. The key use end date is a date on which the DID-issue-right-key provided control device 110 has finished using the DID issue right key. That is, the key use end date is a date on which the control device 110 has finished issuing DIDs to up to the maximum number of eDoc files indicated by the DID issue limit. If the control device 110 is allowed to request the DID server 220 to issue a new DID issue right key and a DID issue limit after finishing issuing the maximum number of DIDs, instead of recording the key use end date of the previous DID issue right key (assumed as a first key), the key provision date of the new DID issue right key may be used as the key use end date of the first key. The issued DID list is a list of DIDs issued by the control device 110 by using the DID issue right key and of the issued dates. Every time the control device 110 issues a DID by using the DID issue right key, it informs the DID server 220 that the DID has been issued, and the DID server 220 adds this DID and the issued date to the issued DID list associated with the DID issue right key included in this DID.

The metadata server 230 stores metadata of each eDoc file sent from the individual control devices 110. The content of metadata to be stored is similar to that shown in FIG. 3. However, among the items of metadata shown in FIG. 3, items only used by the document use terminal 104, such as the document acquisition date and the metadata acquisition date, are not managed by the metadata server 230.

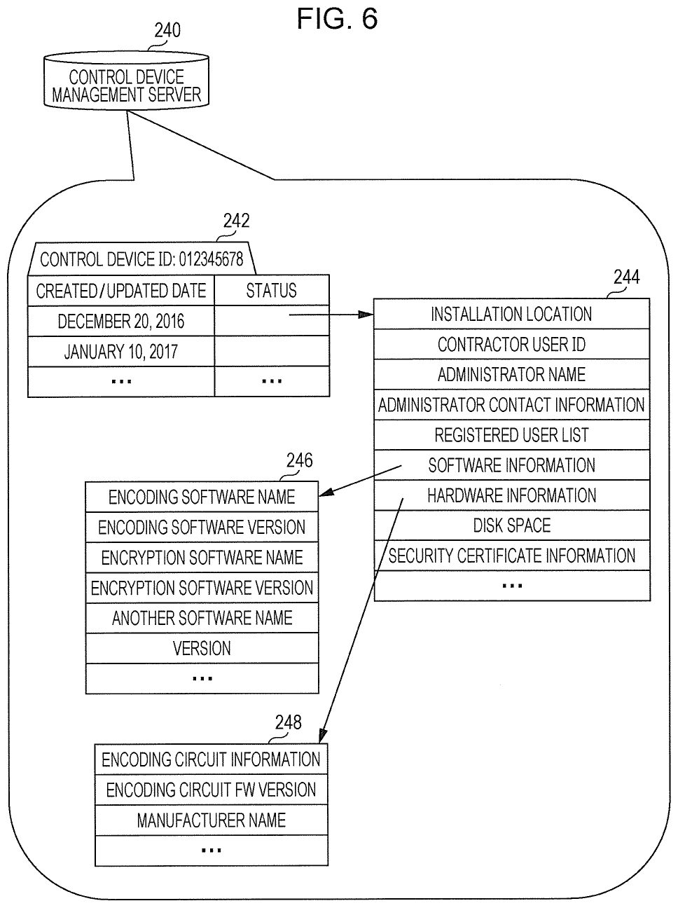

Data managed by the control device management server 240 will be discussed below with reference to FIG. 6. The control device management server 240 stores a status history 242 for each control device 110. In association with the ID of the control device 110, the status history 242 includes information concerning a status 244 of this control device 110 at a time point at which the status history 242 is created or updated (created/updated date).

The status 244 of the control device 110 at each time point indicates an installation location, a contractor user ID, an administrator name, administrator contact information, a registered user list, software information 246, hardware information 248, a disk space, and security certificate information. The installation location is information indicating the installation location of the control device 110, such as the address, building name, and floor. The contractor user ID is the ID of the contractor user using the control device 110. The administrator name is the name of the administrator of the control device 110. The administrator is a user managing the control device 110 at the installation location of the control device 110, such as a department in which the control device 110 is installed. The administrator contact information is contact information, such as the email address, of this administrator. The registered user list is a list of the user IDs of users registered in the control device 110, in other words, the users using the control device 110 as the default control device.

The software information 246 includes various items of data indicating the encoding software name, encoding software version, encryption software name, encryption software version, and another software name installed in the control device 110 and its version. The encoding software is software installed in a processing terminal 106 registered in the control device 110. The encryption software is software installed in this processing terminal 106. The encoding software is software for converting (encoding) a document into the dedicated format designed for the document management system. The encryption software is software for encrypting a document, for example, a document converted into the dedicated format. The software name and version of encoding software and the software name and version of encryption software installed in each of the processing terminals 106 registered in the control device 110 are included in the software information 246 in association with the processing terminal ID of the corresponding processing terminal 106. For example, when a processing terminal 106 is authorized by the control device 110, the above-described items of information are added to the software information 246.

The hardware information 248 includes various items of data indicating encoding circuit information, encoding circuit firmware (FW) version, and manufacturer name of the control device 110. The encoding circuit information indicates the type of hardware circuit used for encoding processing. The encoding circuit FW version is the version of firmware (FW) of this encoding circuit. The encoding circuit information and encoding circuit FW version of the encoding circuit installed in each of the processing terminals 106 registered in the control device 110 are included in the hardware information 248 in association with the processing terminal ID of the corresponding processing terminal 106. For example, when a processing terminal 106 is authorized by the control device 110, the above-described items of information are added to the hardware information 248.

The disk space is a space of an auxiliary storage device, such as a hard disk or a solid state disk, of the control device 110 at the corresponding time point.

The security certificate information is information for identifying each security certificate installed in the control device 110 at the corresponding time point. Examples of the security certificate information are a subject identifier, an issuer identifier, and the issued date of a certificate.

The status 244 also includes other items of information, though they are not shown to avoid the complexity. Examples of the other items of information are the font types installed in the control device 110 (font name list), the address used for network communication (IP address, for example), the ID of the auxiliary storage device, such as a hard disk drive, the content of customization made to adapt the control device 110 to processing executed by the backbone system of the organization in which the control device 110 is installed, and the installation date of an encryption key used by the control device 110. This encryption key is used for encrypting a communication channel and a signature, for example.

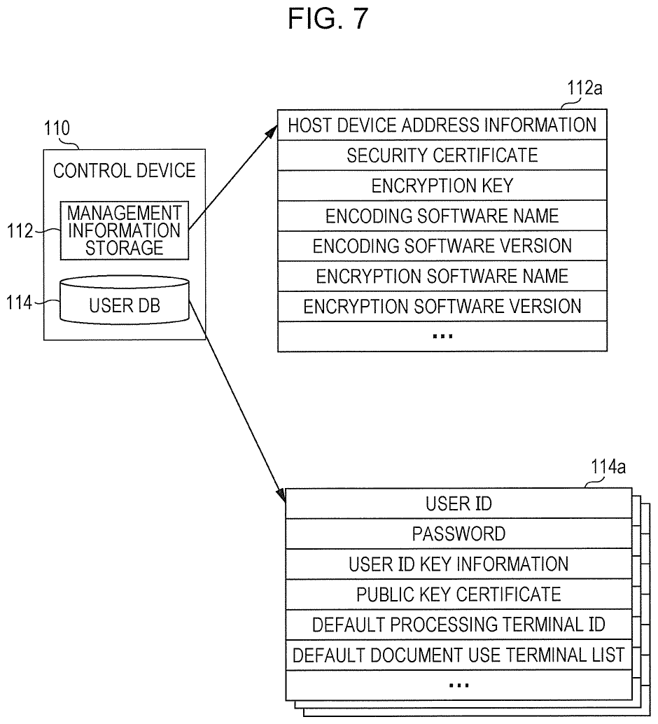

A group of databases stored in the control device 110 will be discussed below with reference to FIG. 7. As shown in FIG. 7, the control device 110 includes a management information storage 112 and a user database (DB) 114.

In the management information storage 112, management information 112a is stored. The management information 112a includes various items of data indicating host device address information, a security certificate, an encryption key, an encoding software name, an encoding software version, an encryption software name, and an encryption software version. The host device address information is information concerning the communication address (such as the IP address or URL) of each host device that manages the control device 110. Examples of the host device are the management system 200 and the user ID server 210, the DID server 220, the metadata server 230, and the control device management server 240 of the management system 200, or an in-house management system 160 and a local user ID server 162, a local DID server 164, and a local metadata server 166 of the in-house management system 160, which will be discussed later. The security certificate is a digital certificate used by the control device 110 to conduct secure communication with another device on a network based on a public key infrastructure. The control device 110 stores the security certificates of host devices which frequently communicate with the control device 110. The control device 110 may also store the security certificate of each user using the document creation terminal 102 and the document use terminal 104. The encryption key is used by the control device 110 for conducting encryption and decryption when communicating with another device on a network and for generating digital signatures (or for generating certificate information similar to digital signatures). The encryption key is constituted by a pair of a private key and a public key provided to the control device 110 based on the public key infrastructure, for example. The encoding software is encoding software installed in the processing terminal 106 registered in the control device 110 to convert a document into the dedicated format. The encryption software is software installed in the processing terminal 106 registered in the control device 110 to encrypt the document.

In the user DB 114, user information 114a concerning each user registered in the control device 110 (in other words, users using the control device 110 as the default control device) is stored. The user information 114a concerning each registered user includes various items of data, such as a user ID, a password, user ID key information, public key information, such as a public key certificate, a default processing terminal ID, and a default document use terminal list. The content of these items of data is similar to that of the counterparts of the general user data 214 stored in the user ID server 210 shown in FIG. 4.

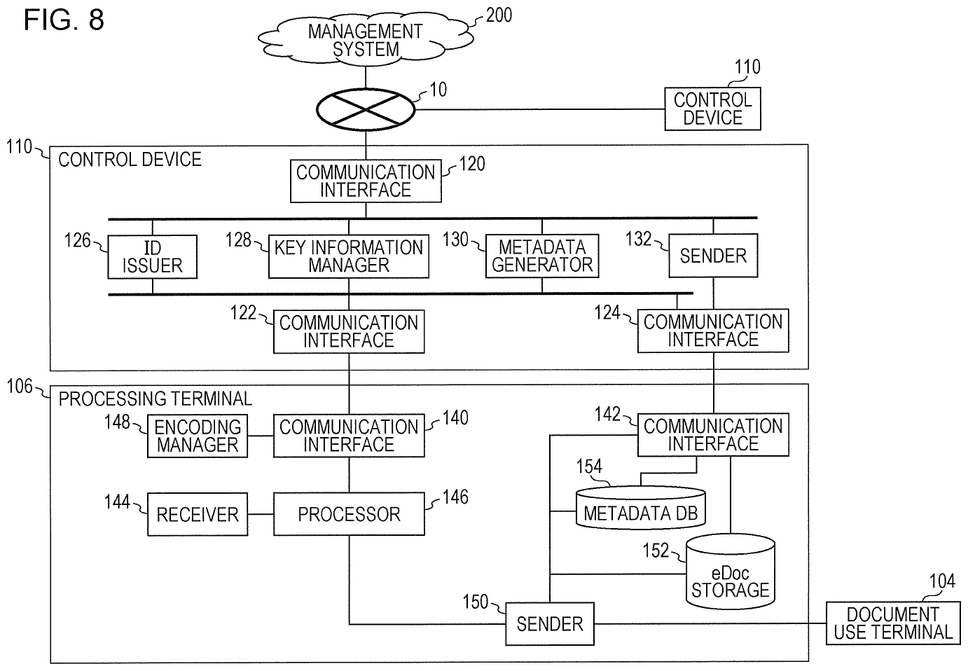

Examples of the functional configurations of the processing terminal 106 and the control device 110 will be described below in detail with reference to FIG. 8.

The control device 110 includes communication interfaces 120, 122, and 124, an ID issuer 126, a key information manager 128, a metadata generator 130, and a sender 132.

The communication interface 120 is used for performing communication via the wide area network 10 with the management system 200 and other control devices 110 installed in the other local systems 100.

The communication interface 122 communicates with a communication interface 140 of the processing terminal 106 by using a communication method which satisfies a specific communication condition, for example, a secure communication method, such as SSL, so as to exchange with the processing terminal 106 information used for processing to be executed by the processing terminal 106. Examples of such information are a DID, user ID, contract information, and key information.

The communication interface 124 communicates with a communication interface 142 of the processing terminal 106 by using a communication method which satisfies a specific communication condition, for example, a secure communication method, such as SSL, so as to receive a processed document, such as an eDoc file, from the processing terminal 106 and exchange metadata with the processing terminal 106.

The ID issuer 126 issues a DID to be appended to a processed document, such as an eDoc file, generated by the processing terminal 106. The DID server 220 has provided a DID issue right and the accompanying DID issue limit to the control device 110. The DID issue limit is a restriction regarding the maximum number of documents to which DIDs can be appended, as stated above. DIDs are not unlimitedly issued and are limited to the number indicated by the DID issue limit. To put it another way, the ID issuer 126 can issue DIDs based on a DID issue right to up to the number of documents indicated by the associated DID issue limit received by the DID server 220. After the ID issuer 126 has issued the maximum number of DIDs indicated by the DID issue limit, it receives a new DID issue right and its accompanying DID issue limit from the DID server 220. If the ID issuer 126 has not received a DID issue right and a DID issue limit from the DID server 220 (or if it has issued the maximum number of DIDs), it requests the DID server 220 to issue a new DID issue right and a DID issue limit. In response to a request from the ID issuer 126, the DID server 220 sends a new DID issue right and a DID issue limit to the ID issuer 126. A DID includes information which guarantees that this DID is based on a DID issue right received by the DID server 220 (such information is a DID issue right key, which will be discussed later) and information which guarantees that the control device 110 has issued this DID based on the DID issue right (such information is a DID issue certifying key, which will be discussed later). A DID issued by the ID issuer 126 is appended to a processed document, such as an eDoc file, by the processing terminal 106, which will be discussed later.

The key information manager 128 manages encryption information concerning encryption to be conducted on a file, such as an eDoc file, when the file is generated. The encryption information indicates the name and the version of encryption software used for encrypting the file and also includes key information indicating the key for decrypting the encrypted file. The key information is information generated by encrypting the key for decrypting the file with the public key of each document receiver user.

The key information manager 128 obtains environment information and processing terminal information from an encoding manager 148 of the processing terminal 106 via the communication interfaces 122 and 140 by using a communication method which satisfies a specific communication condition, for example, a secure communication method, such as SSL. The environment information is information concerning the environments of document processing to be executed by the processing terminal 106. The processing terminal information is information concerning the processing terminal 106. The key information manager 128 then judges whether to permit the processing terminal 106 to execute document processing, based on the obtained environment information and processing terminal information. If the obtained environment information and processing terminal information satisfy specific processing conditions, the key information manager 128 permits the processing terminal 106 to execute document processing. The key information manager 128 then sends permission information indicating that the processing terminal 106 is permitted to execute document processing to the processing terminal 106 via the communication interfaces 122 and 140 by using a secure communication method, such as SSL. The permission information is then stored in the processing terminal 106.

Upon receiving metadata from the processing terminal 106, the metadata generator 130 adds certain items of data to the metadata and sends the resulting metadata to the metadata server 230. This metadata is registered in the metadata server 230. The metadata generator 130 also sends this metadata to the processing terminal 106. The metadata is then registered in a metadata DB 154. For example, if access right information and document receiver information are not included in the metadata, the metadata generator 130 adds default access right information and document receiver information to the metadata. The metadata generator 130 also adds metadata generation log information to the metadata. The metadata is stored in the metadata DB 154 of the processing terminal 106, which will be discussed later. The metadata generator 130 then adds storage log information and storage location information to the metadata.

The sender 132 sends a processed document, such as an eDoc file, to another control device 110, which is a document receiver, via the communication interface 120.

The processing terminal 106 includes communication interfaces 140 and 142, a receiver 144, a processor 146, an encoding manager 148, a sender 150, an eDoc storage 152, and a metadata DB 154.

The communication interface 140 communicates with the communication interface 122 of the control device 110 by using a communication method which satisfies a specific communication condition, for example, a secure communication method, such as SSL, so as to exchange with the control device 110 information used for processing to be executed by the processing terminal 106. Examples of such information are a DID, user ID, contract information, and key information.

The communication interface 142 communicates with the communication interface 124 of the control device 110 by using a communication method which satisfies a specific communication condition, for example, a secure communication method, such as SSL, so as to send a processed document, such as an eDoc file, to the control device 110 and exchange metadata with the control device 110.

The receiver 144 receives a document to be registered, document name, distributor user ID, document receiver information, access right information, offline effective period, and original data information sent from a document creation terminal 102.

When the key information manager 128 of the control device 110 has provided permission to execute document processing to the processing terminal 106, the processor 146 generates a processed document, such as an eDoc file, by executing processing on a document received from a document creation terminal 102 by the receiver 144. In one example, the processor 146 generates an eDoc file by encoding a document into the dedicated format designed for the document management system and by encrypting the encoded data with an encryption key. The order of encoding and encrypting may be reversed. In another example, the processor 146 may execute protection processing on a document to be registered without executing format conversion processing. The processor 146 may alternatively execute format conversion processing on the document without executing protection processing. The processor 146 also appends the unique DID to the processed document, such as an eDoc file. The DID is issued by the control device 110 and is sent to the processing terminal 106. The DID includes a DID issue right key and a DID issue certifying key.

The processor 146 also generates metadata associated with the processed document, such as an eDoc file. The metadata includes the attribute data received from the document creation terminal 102, together with the document, information received from the control device 110 and used for processing executed by the processor 146, and the values of attributes created by the processor 146. The key information included in the metadata is information indicating a key for decrypting the eDoc file. If common-key cryptosystem is used, the key information is information indicating the common key. However, if the common key itself is included in metadata as plaintext, it may be abused by interception, for example. The common key is thus encrypted with the public key of a document receiver user and is integrated within the metadata as the key information.

The processor 146 outputs the generated processed document, such as an eDoc file, and the metadata to the sender 150.

The encoding manager 148 sends environment information concerning the environments of document processing to be executed by the processing terminal 106 and processing terminal information concerning the processing terminal 106 to the key information manager 128 of the control device 110 via the communication interfaces 140 and 122 by using a communication method which satisfies a specific communication condition, for example, a secure communication method, such as SSL. In response to the key information manager 128 having provided permission to execute document processing to the processing terminal 106, the encoding manager 148 receives permission information from the key information manager 128.

The sender 150 stores the processed document, such as an eDoc file, generated by the processor 146 in the eDoc storage 152. The sender 150 also sends the metadata generated by the processor 146 to the control device 110 via the interfaces 142 and 124 by using a communication method which satisfies a specific communication condition, for example, a secure communication method, such as SSL. As stated above, the metadata generator 130 of the control device 110 adds certain items to this metadata. The resulting metadata is sent from the control device 110 to the processing terminal 106. The sender 150 stores this metadata in the metadata DB 154.

The sender 150 distributes the processed document, such as an eDoc file, generated by the processor 146 to a document use terminal 104 specified as a document receiver. Push-type distribution or pull-type distribution may be performed to distribute the document. A combination of push-type distribution and pull-type distribution may alternatively be performed. For example, when the processed document is generated, the sender 150 distributes it to the document use terminal 104 (push-type distribution), and if the document use terminal 104 has failed to receive the document because it is not in operation, it requests the processing terminal 106 to send the document (pull-type distribution). Distribution of the document is conducted via the local network 108 within the local system 100. Instead of sending the processed document to the document use terminal 104, the sender 150 may send information indicating that the processed document has been generated to the document use terminal 104.

When sending the processed document, such as an eDoc file, to another control device 110, the sender 150 first sends the processed document to the control device 110 shown in FIG. 8 via the communication interfaces 142 and 124 by using a communication method which satisfies a specific communication condition, for example, a secure communication method, such as SSL. The sender 132 of the control device 110 receives this processed document and distributes it to another control device 110.

In the eDoc storage 152, eDoc files generated by the processor 146 are stored.

In the metadata DB 154, generated metadata is stored.

Each of a processed document, such as an eDoc file, and metadata is appended with a DID and can thus be associated with each other. In the eDoc storage 152, the original data of a processed document (original data received from a document creation terminal 102) may be registered in association with the DID of this processed document.

In the system configured as described above, information used for processing (encoding) to be executed by the processing terminal 106, such as a DID, user ID, contract information, and key information, are sent and received between the key information manager 128 and the encoding manager 148 via the communication interfaces 122 and 140 with a communication method which satisfies a specific communication condition, for example, a secure communication method, such as SSL. To send and receive the above-described information, permission information is used for verifying the authenticity of the processing terminal 106. If permission information within the effective period is stored in the processing terminal 106, the information used for processing to be executed by the processing terminal 106 is sent from the key information manager 128 to the encoding manager 148.

### (Status Management for Control Device)

Control processing concerning status management for a control device 110 will be discussed below.

The control device 110 regularly informs the management system 200 of the status of the control device 110. In the management system 200, the control device management server 240 adds the received status to the status history 242 concerning this control device 110 in association with the received date. The control device management server 240 also checks the received status and performs control processing regarding whether to permit the control device 110 to provide a service to a user, based on the checking result.

The status regularly sent from the control device 110 to the control device management server 240 includes items similar to those of the status 244 shown in FIG. 6.

The control device management server 240 performs control to judge whether to permit the control device 110 to execute processing, based on the status sent from the control device 110. For example, the control device management server 240 judges whether the control device 110 satisfies predetermined security conditions, based on the status of the control device 110. If the control device 110 satisfies the predetermined security conditions, the control device management server 240 permits the control device 110 to execute processing. If the control device 110 does not satisfy the predetermined security conditions, the control device management server 240 does not permit the control device 110 to execute processing. This will be discussed below in detail.

Upon receiving the status from the control device 110, the control device management server 240 checks the values of subject items of the status against the standards of these items. Items of the status to be checked include the encryption software name and version and encoding software name and version installed in each of the processing terminals 106 registered in the control device 110, security certificates, information concerning the encryption key, such as a pair of a private key and a public key, used for encrypting a communication channel and signatures installed in the control device 110 (such information includes identification information and installation date of the encryption key, for example), encoding circuit name and FW version installed in each of the processing terminals 106, types of fonts installed in the control device 110, and disk (auxiliary storage) space. Examples of the standards of the individual items are as follows. The version of each of the encryption software, encoding software, and FW is the latest version or a certain version or later one, the value of the disk space is greater than or equal to a predetermined threshold, there is no blacklisted security certificate among those installed in the control device 110, a predetermined period has not elapsed after the installation date of the encryption key in the control device 110, and a predetermined type of font is installed.

For example, to maintain the security of the encryption key used by the control device 110 to encrypt a communication channel and signatures, the encryption key is desirably changed to a new one on a regular basis. If the predetermined period has elapsed after the installation date of the encryption key, the control device management server 240 judges that this encryption key does not satisfy the standard. The control device management server 240 then determines that the control device 110 is not allowed to provide a service, or issues a warning that the control device 110 will not be allowed to provide a service. The control device management server 240 then instructs the control device 110 to replace the encryption key by a new one.

The control device management server 240 then judges whether, among the items of the status to be checked, there is an item that does not satisfy the corresponding standard. If there is no such an item, the control device management server 240 terminates the control processing of status management for the control device 110. If there is such an item, the control device management server 240 informs the control device 110 that the control device 110 is not allowed to provide a service. Upon receiving this information, the control device 110 stops registering (distributing) a document in the document management system. That is, the control device 110 does not permit any processing terminal 106 registered in the control device 110 to execute document processing. The processing terminal 106 does not receive a request to register (distribute) a document from any document creation terminal 102 and returns a message that the provision of services is not available for the time being to the document creation terminal 102.

Under this control processing, the possibility that the control device 110 will create an eDoc file having a poor quality that does not satisfy the standards is reduced.

### (Processing Procedure in Document Management System)

When a control device 110 is disposed on the local network 108, maintenance staff conducting maintenance of the control device 110 registers in the control device 110 information concerning users using the control device 110 and information concerning document creation terminals 102, document use terminals 104, and processing terminals 106 that may be used by these users. The registered user information is also transferred to and registered in a host device, such as the user ID server 210 (or the local user ID server 162, which will be discussed later). After the control device 110 is disposed on the local network 108, if a new user is added or a user among the users using the control device 110 is deleted, the maintenance staff registers information concerning the new user or deletes information concerning the deleted user. Information concerning such addition or deletion of users is also supplied to the host device, such as the user ID server 210, and information stored in the host device is accordingly updated. The maintenance staff also installs software in each document creation terminal 102 for requesting the processing terminal 106 and the control device 110 to register or distribute a document. This software may be installed as a device driver for communicating with the processing terminal 106 and the control device 110. The maintenance staff also registers information for communicating with the control device 110 (such as the device name, communication address, and wireless access settings) in each document use terminal 104.

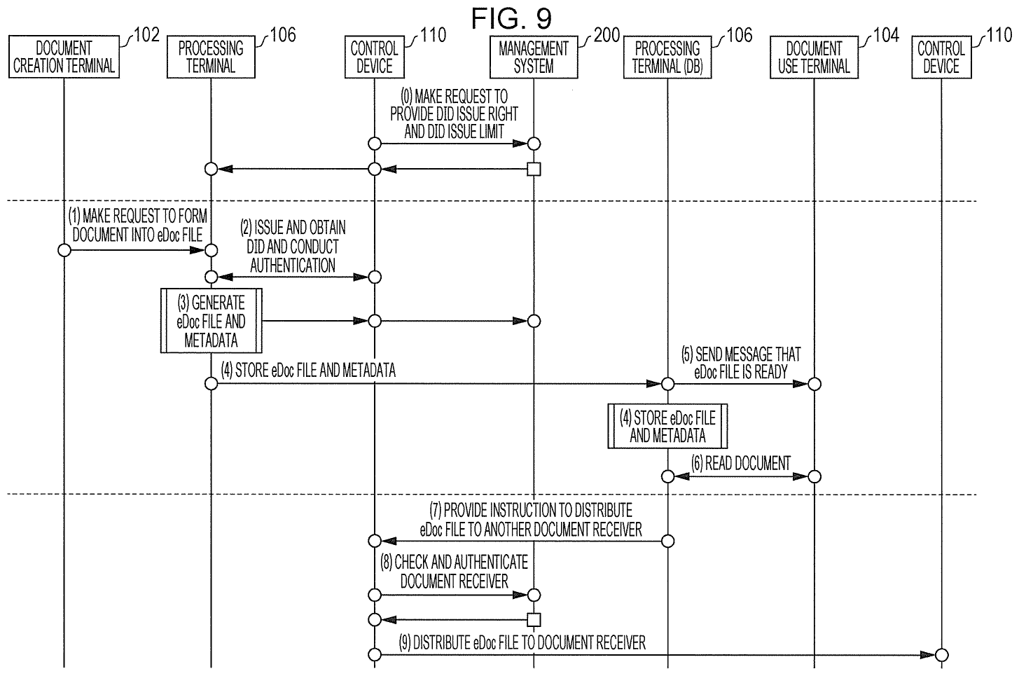

Processing executed by the document management system according to the exemplary embodiment will be explained below with reference to FIG. 9.

(0) The control device 110 requests the DID server 220 to provide a DID issue right and the accompanying DID issue limit. In response to this request, the DID server 220 provides a DID issue right and the accompanying DID issue limit to the control device 110. DIDs are not unlimitedly issued and are limited to the number indicated by the DID issue limit. To put it another way, the control device 110 can append DIDs based on a DID issue right to up to the number of documents indicated by the associated DID issue limit. After the control device 110 has appended DIDs to up to the maximum number of documents, it receives a new DID issue right and the associated DID issue limit from the DID server 220.

(1) To register (distribute) a document in the document management system, a user instructs a document creation terminal 102 to register the document by selecting a “register” button on an application menu, for example. Upon receiving this instruction, the document creation terminal 102 requests the user to conduct user authentication. To conduct user authentication, the user may input a user ID and a password or pass the authentication device 109 over a card reader of the document creation terminal 102. User authentication may be conducted by the document creation terminal 102 or the processing terminal 106 to which the document will be sent or the control device 110 which manages the processing terminal 106. The user then selects a document from the documents stored in the document creation terminal 102 and instructs it to register the selected document in the document management system.

In response to an instruction to register the selected document from the user, the document creation terminal 102, and more specifically, a register processing program installed in the document creation terminal 102, receives input of some items of attribute data concerning this document which are set by the user. An example of some items of the attribute data to be set by the user is a document receiver of this document. As the document receiver, the document creation terminal 102 may receive a combination of a user and a document use terminal 104. When the combination of this user and the document use terminal 104 match the combination set as the document receiver, this user can use the document. The user and the document use terminal 104 set as the document receiver are those registered in the control device 110. By using the document creation terminal 102, the distributor user may set access rights for the document receiver user, such as read, edit, print, and copy rights, and the offline effective period.

The document creation terminal 102 combines the items input by the user, such as the document receiver, with other items generated by the document creation terminal 102, such as register user information and document creation date, so as to form attribute data. The document creation terminal 102 then sends the attribute data, together with the document data, to the default processing terminal 106. In the document creation terminal 102, the processing terminal ID of the default processing terminal 106 and address information have been stored. The document creation terminal 102 sends the document and attribute data to this default processing terminal 106. If multiple default processing terminals 106 are set, the user may select one default processing terminal 106 to execute processing on the document. The document creation terminal 102 sends the document and attribute data to the processing terminal 106 selected by the user. The document creation terminal 102 may contain a driver for converting documents of various formats created by various applications into the uniform format that can be handled by the document use terminals 104. For example, if the original document is still image document data, such as data created by word-processing software, a spreadsheet, or CAD data, the driver converts such data into a document described in a page description language (PDL), as a printer driver does. If the original document is sound data, the driver converts it into data (document) of a specific sound data format that can be handled by the document management system (in particular, the document use terminals 104).

(2) The processing terminal 106 receives the document and attribute data from the document creation terminal 102. If permission information within the effective period is stored in the processing terminal 106, the processing terminal 106 sends this permission information to the control device 110 in which the processing terminal 106 is registered by using a secure communication method, such as SSL. At the same time, the processing terminal 106 sends a request to send information to be used for processing, such as a DID, user ID, contract information, and key information, to the control device 110. In response to this request, the ID issuer 126 of the control device 110 issues a DID by using the DID issue right provided by the DID server 220. The DID contains a DID issue right key and a DID issue certifying key. The key information manager 128 of the control device 110 then sends the information to be used for processing to the encoding manager 148 of the processing terminal 106 by using a secure communication method, such as SSL. If permission information is not stored in the processing terminal 106 or if the effective period of the permission information stored in the processing terminal 106 has elapsed, environment information concerning the environments of processing and processing terminal information concerning the processing terminal 106 are sent from the processing terminal 106 to the control device 110. Based on the environment information and processing terminal information, the control device 110 judges whether to permit the processing terminal 106 to execute processing on the document. If the environment information and processing terminal information satisfy specific processing conditions, the control device 110 decides to permit the processing terminal 106 to execute processing on the document and sends permission information to the processing terminal 106.

(3) If the control device 110 has permitted the processing terminal 106 to execute processing on the document, the processor 146 of the processing terminal 106 executes processing on the document received from the document creation terminal 102 so as to generate a processed document. In this example, the processor 146 generates an eDoc file as a result of executing protection processing and format conversion processing on the received document. The processor 146 also appends the DID issued by the control device 110 to the eDoc file. The processor 146 also generates metadata of the generated eDoc file. The metadata includes the attribute data received from the document creation terminal 102 together with the document, the information received from the control device 110, and the values of attribute items created by the processor 146. The processor 146 then outputs the generated eDoc file and metadata to the sender 150.

(4) The sender 150 then stores the eDoc file generated by the processor 146 in the eDoc storage 152.

The sender 150 sends the metadata generated by the processor 146 to the control device 110 via the communication interfaces 142 and 124 by using a communication method which satisfies a specific communication condition, for example, a secure communication method, such as SSL. As stated above, the metadata generator 130 of the control device 110 then adds certain items of data to the metadata. The resulting metadata is sent from the control device 110 to the processing terminal 106. The sender 150 then stores this metadata in the metadata DB 154.

The metadata generator 130 uploads the metadata appended with the new items of data to the metadata server 230. The metadata server 230 stores this metadata. The ID issuer 126 uploads the DID appended to the eDoc file to the DID server 220. The DID server 220 stores this DID.

(5) The sender 150 sends a message that the eDoc file is now ready to be distributed to the corresponding document use terminal 104. This message includes information concerning the DID and the document name of the eDoc file. This message may also include a thumbnail image of a representative page (a predetermined page, such as the head page) of the eDoc file. Instead of sending this message, the sender 150 may directly send the eDoc file to the document use terminal 104.

(6) A user (also called a viewer user) using the document use terminal 104 passes the authentication device 109 of the user over the card reader of the document use terminal 104 so as to conduct user authentication. The document use terminal 104 displays a list screen of a list of eDoc files distributed to the document use terminal 104. The viewer user touches and selects an eDoc file on the list screen to be viewed.

The document use terminal 104 does not have the selected eDoc file and metadata and is thus required to obtain them from the processing terminal 106. The document use terminal 104 first sends a user ID key, which is authentication information, acquired from the authentication device 109 of the viewer user to the processing terminal 106 which is connected to the same local network 108 as the document use terminal 104 and which has sent the above-described message to the document use terminal 104. The processing terminal 106 then conducts user authentication to check whether the user ID key certifies one of the users registered in the processing terminal 106. It is assumed that user authentication has succeeded. If the user ID key received from the document use terminal 104 does not certify any user registered in the processing terminal 106, the processing terminal 106 may send the user ID key to a host device engaged in user authentication (control device 110, user ID server 210, or local user ID server 162) and request it to conduct user authentication.

After user authentication has succeeded, the document use terminal 104 sends a request to distribute the eDoc file selected by the viewer user to the processing terminal 106. The request includes the DID of this file.

The processing terminal 106 sends the eDoc file associated with the DID contained in the request and also metadata of the eDoc file to the document use terminal 104.

The document use terminal 104 receives the eDoc file and metadata sent from the processing terminal 106 and stores (caches) them.

The document use terminal 104 judges whether a combination of the document use terminal 104 and the viewer user currently using the document use terminal 104 matches one of the combinations of receiver users and receiver terminals indicated by the document receiver information (see FIG. 3) included in the metadata. If the combination of the document use terminal 104 and the viewer user is not found, the viewer user is unable to access the eDoc file by using this document use terminal 104. In this case, the document use terminal 104 displays an error message that the eDoc file is not viewable by this document use terminal 104. The document use terminal 104 may delete this stored eDoc file and the associated metadata. If the above-described combination is found, the document use terminal 104 allows the viewer user to access the eDoc file. In this case, the document use terminal 104 extracts the encrypted key corresponding to this viewer user among the encrypted keys corresponding to the individual viewer users contained in the encryption information in the metadata, and decrypts this encrypted key with the private key (stored in the authentication device 109, for example) of the viewer user, thereby reproducing the decryption key for decrypting the eDoc file.

The document use terminal 104 decrypts the eDoc file with the reproduced decryption key so as to reproduce the document, and outputs the document by displaying it on the screen, for example. The document use terminal 104 also judges whether to accept an operation instruction for the document from the viewer user, based on the access right information included in the metadata. Basically, the document use terminal 104 does not store the decrypted document in a file. That is, after the eDoc file is viewed, the document use terminal 104 does not store the decrypted document though it stores the eDoc file and metadata in the non-volatile storage device of the document use terminal 104.

Only the eDoc file may be sent from the processing terminal 106 to the document use terminal 104, and the document use terminal 104 may request the metadata server 230 to send the metadata of the eDoc file. The document use terminal 104 may then receive the metadata from the metadata server 230, decrypt the eDoc file into a document, and output the document by displaying it on the screen, for example.

(7) If an instruction to distribute the eDoc file to another document receiver, such as another local system 100, has been provided from the user using the document creation terminal 102, the processing terminal 106 instructs the control device 110 to distribute the eDoc file to the document receiver.

(8) Upon receiving this instruction, the sender 132 of the control device 110 checks the document receiver. For example, the sender 132 checks with the management system 200 about the document receiver.

(9) The sender 132 then distributes the eDoc file to the document receiver.

In the document management system according to the exemplary embodiment, various processing operations regarding encoding, such as encoding and generating of metadata, are executed by the processing terminal 106, instead of the control device 110. This makes it less likely to concentrate a load on the control device 110 than in the configuration in which these processing operations are executed only by the control device 110. For example, when multiple document creation terminals 102 are registered in one control device 110, if the above-described processing operations regarding encoding are executed on documents sent from the individual document creation terminals 102 only by the control device 110, the load concentrates on the control device 110. In contrast, as a result of the processing terminal 106 executing these operations, the load on the control device 110 can be reduced. If multiple processing terminals 106, such as PCs, are registered in the control device 110, they execute the above-described operations regarding encoding, thereby making it possible to distribute the loads over the individuals PCs. Additionally, the control device 110 judges for each processing terminal 106 whether to permit the processing terminal 106 to execute processing, based on the operating status of the security software and version installed in the processing terminal 106. If the processing terminal 106 is permitted, it executes processing. If the processing terminal 106 is not permitted, it does not execute processing. This achieves secure document processing. For example, if the version of security software or the OS installed in the processing terminal 106 is old, this processing terminal 106 is not permitted to execute processing. This makes it possible to prevent a leakage of documents caused by the vulnerability of security software or the OS.

If the processing terminal 106 that has received a document from a document creation terminal 102 is not a legitimate processing terminal 106, the control device 110 may send an instruction to send the document to a legitimate processing terminal 106 to the document creation terminal 102. For example, such an instruction is displayed on the document creation terminal 102, and the processing terminal ID and address of this legitimate processing terminal 106, for example, are displayed. The illegitimate processing terminal 106 deletes the received document.

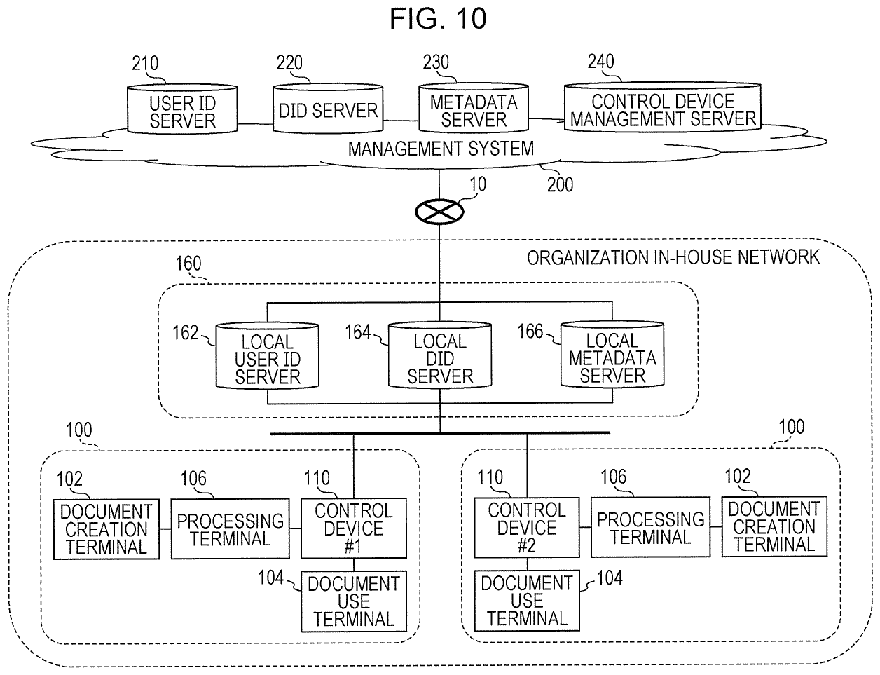

Another example of the document management system of the exemplary embodiment will be described below with reference to FIG. 10. In the example shown in FIG. 10, multiple local systems 100 are disposed within an organization in-house network, which is a private network of an organization, such as a company. Within the organization in-house network, an in-house management system 160 is disposed. The in-house management system 160 manages part of operations and information managed by the document management system 200. That is, the in-house management system 160 manages operations related to the organization and information required for the operations. More specifically, the management system 200, which is operated by a service provider of the document management system, manages information and operations concerning plural organizations using the document management system. In contrast, the in-house management system 160 manages information and operations concerning the organization within the organization in-house network, under the management of the management system 200.

The in-house management system 160 includes a local user ID server 162, a local DID server 164, and a local metadata server 166.

The local user ID server 162 manages information concerning members of the organization who are registered as users of the document management system. Information concerning the individual users stored in the local user ID server 162 is similar to the general user information stored in the user ID server 210 shown in FIG. 4. When a user is registered in a control device 110, that is, when a user using a control device 110 as the default control device is registered, the control device 110 sends information concerning this registered user to the local user ID server 162 within the organization. The local user ID server 162 stores the user information and also sends it to the user ID server 210 of the management system 200 via the wide area network 10. The user ID server 210 stores the user information. If any change is made to information concerning a user registered in the control device 110, the administrator, for example, updates the information concerning this user stored in the control device 110. The control device 110 sends the content of a change made to the information concerning this user (such as the user ID, the name of an item of information to which a change is made, and the updated value of this item) to the local user ID server 162. The local user ID server 162 then changes the information concerning this user stored in the local user ID server 162 in accordance with the content of a change. The local user ID server 162 also sends information concerning the content of a change to the user ID server 210. The user ID server 210 changes the information concerning this user stored in the user ID server 210 accordingly.

The local DID server 164 receives DIDs issued by the control devices 110 of the individual local systems 100 disposed within the organization in-house network, and stores the received DIDs. Information stored in the local DID server 164 is similar to that stored in the DID server 220 shown in FIG. 5. The local DID server 164 sends information concerning the DIDs received from the control devices 110 to the DID server 220, and the DID server 220 stores this information. The local DID server 164 receives a DID issue right and a DID issue limit from the DID server 220. Based on this DID issue right, the local DID server 164 provides a DID issue right and a DID issue limit to each control device 110 disposed within the organization in-house network within the range of the DID issue limit received from the DID server 220.

The local metadata server 166 receives metadata of each of processed documents, such as eDoc files, generated by the control devices 110 of the individual local systems 100 disposed within the organization in-house network, and stores the received metadata. Information stored in the local metadata server 166 is similar to that of the metadata server 230. The local metadata server 166 also sends the metadata received from the control devices 110 to the metadata server 230, and the metadata server 230 stores the metadata.

In the example of the document management system shown in FIG. 10, when a request is made to register and distribute a document or to obtain a processed document, such as an eDoc file, or metadata from a user who is not registered in a subject control device 110 but is registered in another control device 110 within the same organization, the subject control device 110 executes processing by responding to this request via the in-house management system 160.

The configuration of a DID used as identification information concerning a processed document in the document management system will be discussed below.

A DID includes a DID issue right key, control device unique information, a DID issued date, a DID issue certifying key, and a DID issue number.

The DID issue right key is key information for identifying a DID issue right provided to a control device 110 by the DID server 220. Upon receiving a request to provide a DID issue right and a DID issue limit from a control device 110, the DID server 220 generates a DID issue right key and sends it, together with a numerical value indicating a DID issue limit (100 documents, for example), to the control device 110. If the local DID server 164 intervenes between the DID server 220 and the control device 110, the DID server 220 provides plural combinations of DID issue right keys and DID issue limits to the local DID server 164. This may mean that the DID server 220 has delegated the task of providing these plural combinations of DID issue right keys and DID issue limits to the control devices 110 to the local DID server 164. Upon receiving a request to provide a DID issue right from a control device 110 managed by the local DID server 164, the local DID server 164 provides a combination of an unassigned DID issue right key and a DID issue limit to the control device 110.

The control device unique information is information unique to the control device 110 that has issued the DID. That is, checking the control device unique information within the DID can uniquely identify the control device 110 that has issued this DID. The control device unique information is stored in the control device 110.

The DID issued date is a character string representing the date (year, month, and day) on which the DID is issued. The DID issued date is also the date on which the eDoc file appended with the DID is generated (encoded).

The DID issue certifying key is key information certifying that the control device 110 identified by the control device unique information has issued the DID by using the DID issue right indicated by the DID issue right key. The DID issue certifying key is a value generated by encrypting the DID issue right key with the private key of this control device 110. In this case, if the value generated by decrypting the DID issue certifying key with the public key of the control device 110 matches the DID issue right key, the DID is certified as information issued by this control device 110 by using the DID issue right key. Alternatively, the value generated by encrypting the value of the portion of the DID other than the DID issue right key (or the hash value having a predetermined number of digits generated from the value of this portion) with the private key of the control device 110 may be used as the DID issue certifying key. In this case, if the value generated by decrypting the DID issue certifying key with the public key of the control device 110 matches the value of the above-described portion of the DID (or the hash value), the DID is certified as information issued by this control device 110 by using the DID issue right key, and it is verified that the portion of the DID other than the DID issue certifying key is not falsified.

The DID issue number is a serial number of DIDs issued by the control device 110 based on the DID issue right key. The maximum value of the DID issue number of a DID issued by using a certain DID issue right key is the value of the DID issue limit (maximum number of documents) provided by the DID server 220 (or the local DID server 164) with this DID issue right key.

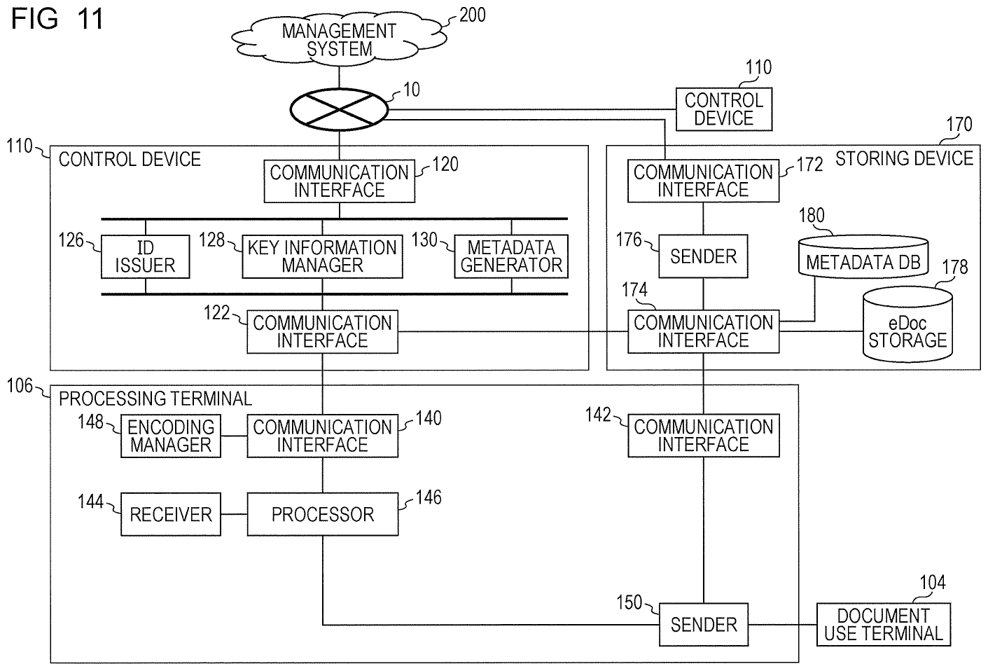

Another example of the document management system according to the exemplary embodiment will now be explained below with reference to FIG. 11. In the example in FIG. 11, the document management system also includes a storing device 170. In this example, a processed document, such as an eDoc file, and metadata are not stored in the processing terminal 106, but is stored in the storing device 170.

The storing device 170 includes communication interfaces 172 and 174, a sender 176, an eDoc storage 178, and metadata DB 180.

The communication interface 172 is used for performing communication via the wide area network 10 with the management system 200 and other control devices 110 installed in the other local systems 100.

The communication interface 174 communicates with a communication interface 122 of the control device 110 and the communication interface 142 of the processing terminal 106 by using a communication method which satisfies a specific communication condition, for example, a secure communication method, such as SSL. For example, the communication interface 174 communicates with the communication interface 122 of the control device 110 so as to receive metadata and a DID from the control device 110. The communication interface 174 also communicates with the communication interface 142 of the processing terminal 106 so as to receive an eDoc file from the processing terminal 106.

The sender 176 sends metadata received from the control device 110 to the metadata server 230 via the communication interface 172. The sender 176 also stores this metadata in the metadata DB 180. The sender 176 also stores a processed document, such as an eDoc file, received from the processing terminal 106 in the eDoc storage 178. If a document receiver is specified, the sender 176 distributes a processed document, such as an eDoc file, to a control device 110 corresponding to the document receiver via the communication interface 172.

In the eDoc storage 178, a processed document, such as an eDoc file, sent from the processing terminal 106 is stored. The sender 150 of the processing terminal 106 sends a processed document generated by the processor 146 to the storing device 170 via the communication interfaces 142 and 174.

In the metadata DB 180, metadata sent from the control device 110 is stored.

If a combination of the control device 110 and the storing device 170 matches the predetermined content, communication using a communication method which satisfies a specific communication condition is established between the control device 110 and the storing device 170. For example, in the control device 110, a storing device 170 authorized to communicate with the control device 110 is registered in advance. Then, a combination of the control device ID of the control device 110 and the storing device ID, which is identification information for identifying the storing device 170, is created in advance and is stored in the control device 110. At the start of communication with a storing device 170, the control device 110 obtains the storing device ID of this storing device 170 and checks whether a combination of the obtained storing device ID and the control device ID is stored in the control device 110. If such a combination is stored in the control device 110, the control device 110 permits the storing device 170 to communicate with the control device 110. Communication between the control device 110 and the storing device 170 is then established so that they can send and receive information with each other. If the combination of the control device ID and the storing device ID is not stored in the control device 110, the control device 110 does not permit the storing device 170 to communicate with the control device 110. In this case, communication between the control device 110 and the storing device 170 is not established, and they are unable to send and receive information with each other.

In the example in FIG. 11, the cabinet ID, which is identification information concerning the storing device 170, is added to the metadata shown in FIG. 3. Upon receiving the metadata generated by the processing terminal 106, the metadata generator 130 adds the cabinet ID of the storing device 170 to the metadata. For example, when the storing device 170 is registered in the control device 110, the cabinet ID of the storing device 170 may be stored in the control device 110, and the metadata generator 130 may add the cabinet ID to the metadata. Alternatively, when adding the cabinet ID to the metadata, the metadata generator 130 may obtain this cabinet ID from the storing device 170 connecting to the control device 110 and then add the obtained cabinet ID to the metadata. The metadata generator 130 sends the metadata appended with the cabinet ID to the storing device 170. The sender 176 of the storing device 170 stores the received metadata in the metadata DB 180. The sender 176 also sends the metadata to the metadata server 230 and registers it in the metadata server 230.

When the processor 146 has generated a processed document, such as an eDoc file, the sender 150 sends a message that the processed document is now ready to be distributed to the corresponding document use terminal 104. The document use terminal 104 then sends a request to distribute a processed document selected by a viewer user to the storing device 170. This request includes the DID of the processed document. The storing device 170 sends the processed document corresponding to the DID included in the request sent from the document use terminal 104 and also the metadata corresponding to the processed document to the document use terminal 104.

The document use terminal 104 judges whether a combination of the document use terminal 104 and the viewer user currently using the document use terminal 104 matches one of the combinations of receiver users and receiver terminals indicated by the document receiver information included in the metadata. If the combination of the document use terminal 104 and the viewer user is found and if the processed document is an encrypted document, such as an encrypted eDoc file, the document use terminal 104 decrypts the processed document so as to reproduce the document that can be viewed by the viewer user and outputs the document by displaying it on the screen, for example, as discussed above. If the combination of the document use terminal 104 and the viewer user is not found, the document use terminal 104 displays an error message that the document is not viewable by this document use terminal 104.

As a result of storing a processed document, such as an eDoc file, and metadata in the storing device 170, the document use terminal 104 is able to obtain the processed document and the metadata from the storing device 170 even when it is unable to obtain them from the processing terminal 106 because the processing terminal 106 is powered OFF or it is not in operation.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A document management system comprising:
a control device disposed on a local network;
a processing terminal disposed on the local network; and
a management apparatus that is disposed on an external network connected to the local network and permits the control device to execute processing if the control device satisfies a predetermined security condition,
the control device including
a first processor configured to
obtain environment information and processing terminal information from the processing terminal by using a communication method which satisfies a specific communication condition, the environment information being information concerning an environment of processing to be executed on a document by the processing terminal, the processing terminal information being information concerning the processing terminal, and
permit the processing terminal to execute processing on the document if the environment information and the processing terminal information satisfy a specific processing condition,
the processing terminal including
a second processor configured to
execute processing on the document so as to generate a processed document if the control device has permitted the processing terminal to execute processing on the document.

2. The document management system according to claim 1, wherein:
the management apparatus includes
a third processor configured to
provide document-ID issue right information to the control device, the document-ID issue right information being information indicating a right to issue a document ID,
receive a document ID issued to the processed document by the control device from the control device, and
store the received document ID in a memory;
the first processor is further configured to
add the document-ID issue right information provided by the management apparatus and certifying information to the document ID and issue the document ID appended with the document-ID issue right information and the certifying information to the processed document, the certifying information being information which certifies that the document ID is an ID issued by the control device; and
the second processor is further configured to
append the document ID issued by the control device to the processed document.

3. The document management system according to claim 2, wherein:
the second processor is further configured to
obtain document receiver information indicating a receiver user and a receiver terminal, and
generate metadata, the metadata being used for making the processed document available in a document use terminal if a user to use the processed document and the document use terminal respectively match the receiver user and the receiver terminal indicated by the document receiver information, the document use terminal being utilized by the user to use the processed document;
the first processor is further configured to
send the document ID issued to the processed document and the metadata to the management apparatus; and
the third processor is further configured to
receive the document ID and the metadata sent from the control device, and
store the received document ID and the received metadata in a memory in association with each other.

4. The document management system according to claim 3, wherein the metadata generated by the second processor includes a processing terminal ID for identifying the processing terminal that has executed processing on the document.

5. The document management system according to claim 4, wherein authenticity of the processed document is verified in accordance with whether the processing terminal ID is associated with a control device ID for identifying the control device to which the document-ID issue right information is provided by the third processor.

6. The document management system according to claim 3, wherein the second processor is further configured to
send the processed document and the metadata to the document use terminal.

7. The document management system according to claim 4, wherein the second processor is further configured to
send the processed document and the metadata to the document use terminal.

8. The document management system according to claim 5, wherein the second processor is further configured to
send the processed document and the metadata to the document use terminal.

9. The document management system according to claim 1, wherein, when a combination of the control device and the processing terminal match predetermined content, the communication method satisfies the specific communication condition, and communication using the communication method is established between the control device and the processing terminal.

10. The document management system according to claim 2, wherein, when a combination of the control device and the processing terminal match predetermined content, the communication method satisfies the specific communication condition, and communication using the communication method is established between the control device and the processing terminal.

11. The document management system according to claim 3, wherein, when a combination of the control device and the processing terminal match predetermined content, the communication method satisfies the specific communication condition, and communication using the communication method is established between the control device and the processing terminal.

12. The document management system according to claim 4, wherein, when a combination of the control device and the processing terminal match predetermined content, the communication method satisfies the specific communication condition, and communication using the communication method is established between the control device and the processing terminal.

13. The document management system according to claim 5, wherein, when a combination of the control device and the processing terminal match predetermined content, the communication method satisfies the specific communication condition, and communication using the communication method is established between the control device and the processing terminal.

14. The document management system according to claim 6, wherein, when a combination of the control device and the processing terminal match predetermined content, the communication method satisfies the specific communication condition, and communication using the communication method is established between the control device and the processing terminal.

15. The document management system according to claim 7, wherein, when a combination of the control device and the processing terminal match predetermined content, the communication method satisfies the specific communication condition, and communication using the communication method is established between the control device and the processing terminal.

16. The document management system according to claim 1, wherein the environment information includes at least one of information concerning security software installed in the processing terminal, information concerning an operating system installed in the processing terminal, and information concerning software used for processing to be executed on the document.

17. A document management system comprising:
a control device disposed on a local network;
a processing terminal disposed on the local network;
a storing device disposed on the local network; and
a management apparatus that is disposed on an external network connected to the local network and permits the control device to execute processing if the control device satisfies a predetermined security condition,
the control device including
a first processor configured to
judge whether to permit the processing terminal to execute processing on a document,
the processing terminal including
a second processor configured to
execute processing on the document so as to generate a processed document if the control device has permitted the processing terminal to execute processing on the document, and
send the processed document to the storing device by using a communication method which satisfies a specific communication condition,
wherein the storing device stores the processed document.

18. The document management system according to claim 17, wherein:
the second processor is further configured to
obtain document receiver information indicating a receiver user and a receiver terminal, and
generate metadata, the metadata being used for making the processed document available in a document use terminal if a user to use the processed document and the document use terminal respectively match the receiver user and the receiver terminal indicated by the document receiver information, the document use terminal being utilized by the user to use the processed document; and
the first processor is further configured to
add a storing device ID for identifying the storing device to the metadata and send the metadata appended with the storing device ID to the management apparatus.

19. A processing terminal device comprising:
a processor configured to
send environment information and processing terminal information to a control device by using a communication method which satisfies a specific communication condition, the environment information being information concerning an environment of processing to be executed on a document by the processing terminal device, the processing terminal information being information concerning the processing terminal device, the control device being disposed on a local network on which the processing terminal device is disposed, the control device being permitted to execute processing by a management apparatus if the control device satisfies a predetermined security condition, the management apparatus being disposed on an external network connected to the local network,
receive permission information from the control device if the control device has permitted the processing terminal device to execute processing on the document as a result of the environment information and the processing terminal information satisfying a specific processing condition, the permission information indicating that the processing terminal device is permitted to execute processing on the document, and
generate a processed document by executing processing on the document when the permission information is received.

20. A control device comprising:
a processor configured to
obtain environment information and processing terminal information from a processing terminal by using a communication method which satisfies a specific communication condition if the control device is permitted to execute processing by a management apparatus as a result of the control device satisfying a predetermined security condition, the management apparatus being disposed on an external network connected to a local network on which the control device is disposed, the environment information being information concerning an environment of processing to be executed on a document by the processing terminal, the processing terminal information being information concerning the processing terminal, and
permit the processing terminal to execute processing on the document if the environment information and the processing terminal information satisfy a specific processing condition.
